(19) United States
(12) Patent Application Publication
(10) Pub. No.: US 2009/0058995 A1
(43) Pub. Date: Mar. 5, 2009

(54) DATA RECORDING SYSTEM, PROGRAM, SEMICONDUCTOR DEVICE, AND DRIVE RECORDER

(75) Inventor: Ayumi YAMASHITA, Kodaira (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/201,300

(22) Filed: Aug. 29, 2008

(30) Foreign Application Priority Data
Aug. 31, 2007 (JP) 2007-226270
Jun. 17, 2008 (JP) 2008-157630

(51) Int. Cl. H04N 7/18

(52) U.S. Cl. 348/61; 348/E09.002

(57) ABSTRACT

A data recording system includes: a trigger generation section that generates a plurality of triggers each of which is generated when the trigger generation section has detected an event that is to be recorded, a data acquisition section that performs a data acquisition process that acquires and stores the input data in a first storage section, and a data storing section. The data storing section reads first storing-target data corresponding to a first trigger of the plurality of triggers from the first storage section and stores the first storing-target data in a second storage section, the first storing-target data having been acquired within a target period that is a predetermined period beginning at a first time before the generation of the first trigger and ending at a second time after the generation of the first trigger. The data storing section sets a subsequent trigger reception period after the first trigger has been generated. The data storing section stores second storing-target data corresponding to a second trigger of the plurality of the triggers in the first storage section when the second trigger has been generated within the subsequent trigger reception period. The data storing section reads the second storing-target data from the first storage section and stores the second storing-target data in the second storage section.

Japanese Patent Application No. 2007-226270, filed on Aug. 31, 2007, and Japanese Patent Application No. 2008-157630, filed on Jun. 17, 2008, are hereby incorporated by reference in their entirety.

### BACKGROUND OF THE INVENTION

The present invention relates to a data recording system, a program, a semiconductor device, and a drive recorder.

A drive recorder has been known that is provided in a moving body (e.g., car) in order to acquire image data at the time of an accident.

As drive recorder technology, technology that sequentially stores a plurality of pieces of image data acquired by an imaging section in time series in a primary storage section, and, when an accident has been detected, stores the image data that has been acquired in a predetermined period before the accident and stored in the primary storage section in a secondary storage section (nonvolatile external storage medium) has been known (see JP-A-10-250642). According to this technology, since the image data acquired in a predetermined period before the accident can be stored in the secondary storage section, the progress of the accident can be clarified.

An accident is detected based on a value detected by an impact sensor or the like. A large impact normally applied at the time of a collision is used as a trigger, and data acquired in a predetermined period before and after the trigger is read from the primary storage section and stored in the secondary storage section. Since the processing load increases when writing data into the primary storage section while transferring data from the primary storage section to the secondary storage section, a processor provided in a drive recorder generally transfers data from the primary storage section to the secondary storage section after data has been completely written into the primary storage section. Since a power supply or a control system may be damaged due to an accident, it is desirable to transfer data to the secondary storage section as early as possible. Therefore, data is transferred from the primary storage section to the secondary storage after data acquired in a predetermined period after a collision has been stored in the primary storage section, and data acquired subsequently is not stored in the primary storage section.

Accordingly, when a plurality of impacts are successively applied (e.g., in a pile-up), data relating to the second or subsequent impact cannot be obtained using such a system.

### SUMMARY

According to a first aspect of the invention, there is provided a data recording system that records input data, the data recording system comprising:

a trigger generation section that generates a plurality of triggers each of which is generated when the trigger generation section has detected an event that is to be recorded;

a data acquisition section that performs a data acquisition process that acquires and stores the input data in a first storage section; and

a data storing section,

the data storing section reading first storing-target data corresponding to a first trigger of the plurality of triggers from the first storage section and storing the first storing-target data in a second storage section, the first storing-target data having been acquired within a target period that is a predetermined period beginning at a first time before the generation of the first trigger and ending at a second time after the generation of the first trigger,

the data storing section setting a subsequent trigger reception period after the first trigger has been generated, and

the data storing section storing second storing-target data corresponding to a second trigger of the plurality of triggers in the first storage section when the second trigger has been generated within the subsequent trigger reception period, and

the data storing section reading the second storing-target data from the first storage section and storing the second storing-target data in the second storage section.

According to a second aspect of the invention, there is provided a computer-readable medium storing a computer program for controlling a data recording system that records input data, the computer program comprising:

generating a plurality of triggers each of which is generated when an event that is to be recorded is detected;

performing a data acquisition process that acquires and stores the input data in a first storage section; and

storing first storing-target data corresponding to a first trigger of the plurality of triggers within a target period that is a predetermined period beginning at a first time before the generation of the first trigger and ending at a second time after the generation of the first trigger in the first storage section;

reading the first storing-target data from the first storage section and storing the first storing-target data in a second storage section;

setting a subsequent trigger reception period after the first trigger has been generated;

storing second storing-target data corresponding to a second trigger of the plurality of triggers in the first storage section when the second trigger has been generated within the subsequent reception period; and

reading the second storing-target data from the first storage section and storing the second storing-target data in the second storage section.

According to a third aspect of the invention, there is provided a semiconductor device comprising:

a trigger generation section that generates a plurality of triggers each of which is to be generated when the trigger generation section has detected an event that is to be recorded;

a data acquisition section that performs a data acquisition process that acquires and stores input data in a first storage section; and

a data storing section,

the data storing section reading first storing-target data corresponding to a first trigger of the plurality of triggers from the first storage section and storing the first storing-target data in a second storage section, the first storing-target data having been acquired within a target period that is a predetermined period beginning at a first time before the generation of the first trigger and ending at a second time after the generation of the first trigger,

the data storing section setting a subsequent trigger reception period after the first trigger has been generated,

the data storing section storing second storing-target data corresponding to a second trigger of the plurality of triggers in the first storage section when the second trigger has been generated within the subsequent trigger reception period, and

the data storage section reading the second storing-target data from the first storage section and storing the second storing-target data in the second storage section.

According to a fourth aspect of the invention, there is provided a drive recorder comprising:

the above-described data recording system;

an imaging section;

a first storage section; and

a second storage section,

the trigger generation section determining whether or not an event that is to be recorded has occurred based on a detection result of an impact detection section, and generating the plurality of triggers based on the determination result.

### BRIEF DESCRIPTION OF THE SEVERAL VIEWS OF THE DRAWING

FIG. 1 is a functional block diagram showing a data recording system according to one embodiment of the invention.

FIG. 2 is a hardware block diagram showing a drive recorder including a data recording system according to one embodiment of the invention.

FIGS. 3A to 3C are explanatory views showing a successive trigger handling operation according to one embodiment of the invention.

FIG. 4 shows a process flow when a trigger is generated.

FIG. 5 shows a process flow when a trigger is successively generated.

### DETAILED DESCRIPTION OF THE EMBODIMENT

The invention may provide a data recording system, a program, a semiconductor device, and a drive recorder that can record storing-target data obtained in a period necessary and sufficient for data storing events that occur successively.

(1) According to one embodiment of the invention, there is provided a data recording system that records input data, the data recording system comprising:

a trigger generation section that generates a plurality of triggers each of which is generated when the trigger generation section has detected an event that is to be recorded;

a data acquisition section that performs a data acquisition process that acquires and stores the input data in a first storage section; and

a data storing section,

the data storing section reading first storing-target data corresponding to a first trigger of the plurality of triggers from the first storage section and storing the first storing-target data in a second storage section, the first storing-target data having been acquired within a target period that is a predetermined period beginning at a first time before the generation of the first trigger and ending at a second time after the generation of the first trigger,

the data storing section setting a subsequent trigger reception period after the first trigger has been generated, and

the data storing section storing second storing-target data corresponding to a second trigger of the plurality of triggers in the first storage section when the second trigger has been generated within the subsequent trigger reception period, and

the data storing section reading the second storing-target data from the first storage section and storing the second storing-target data in the second storage section.

The acquired data (data recorded in the data recording system) may be image data acquired by a camera module, sound data collected by a microphone, measurement data acquired by a measuring device (sensor), or state data received from a car or another instrument (e.g., tire rotational speed or speed data), for example.

The trigger generation section may detect the data storing event based on a value detected by a sensor such as an impact sensor (may be implemented by an acceleration sensor, a gyrosensor, or the like), a thermosensor, or a speed sensor, or an external input (e.g., sound, temperature, tire rotational speed, or car brake input detection). For example, when the data recording system is provided in a drive recorder or the like, the trigger generation section may detect collision, sudden stop, speeding, or the like as the data storing event.

The first storage section is a rewritable memory, and may be implemented by a (external or internal) RAM such as an SDRAM. The second storage section is a nonvolatile memory that retains data even if power is removed, and may be a flash EEPROM, a flash ROM, a memory card such as a CompactFlash (CF) card or a Secure Digital (SD) card, a memory stick such as a USB memory, or the like.

According to this embodiment, when the data storing events (e.g., collisions) have occurred successively, the target period is extended so that data acquired after the second or subsequent data storing event has occurred can be sufficiently backed up. The storing-target data in the extended target period is stored in the second storage section. Therefore, even when collisions or the like have occurred successively (e.g., in a pile-up), the data can be sufficiently backed up.

According to this embodiment, since the process of storing data in the first storage section and the process of storing data in the second storage section are not performed simultaneously, the processing load can be reduced. When the target period is extended, the operation of storing data in the second storage section is delayed correspondingly. Therefore, data may not be recorded due to battery exhaustion or breakage. According to this embodiment, there can be provided a data recording system that does not perform simultaneously the processes of storing data in the first storage section and storing data in the second storage section and is able to record the storing-target data in a period necessary for the data storing events that occur successively.

(2) In this data recording system, the data storing section may extend the subsequent trigger reception period when an additional trigger has been generated within the subsequent trigger reception period.

For example, when an additional trigger has been generated within the subsequent trigger reception period, the subsequent trigger reception period may be extended by resetting the subsequent trigger reception period after the additional trigger has been generated.

(3) In this data recording system, the data acquisition section may not perform the data acquisition process within a storage process period in which data read from the first storage section is stored in the second storage section.

The data acquisition process may be resumed when the storage process period has been completed.

(4) In this data recording system,

the data acquisition section may suspend the data acquisition process when the number of triggers that have been generated within the subsequent trigger reception period has reached a predetermined value (or a successive trigger maximum value).

The data storing section may stop extending the target period or the subsequent trigger reception period when the number of triggers generated within the subsequent trigger reception period has reached a predetermined value (or a successive trigger maximum value).

(5) In this data recording system, when the target period exceeds a predetermined period, the data acquisition section may not perform the data acquisition process in a period out of the predetermined period.

The data storing section may stop extending the target period or the subsequent trigger reception period when the target period exceeds a predetermined period.

(6) In this data recording system, the data acquisition section may determine a target period permissible value based on information relating to the amount of stored data, and set the predetermined period based on the target period permissible value.

(7) In this data recording system,

the data acquisition section may suspend the data acquisition process when data is read from the first storage section and stored in the second storage section (or a nonvolatile storage section), and resume the data acquisition process when a trigger has been generated after suspending the data acquisition process.

The resume timing may be determined corresponding to the suspension time.

The write start address of the first storage section when resuming the data acquisition process may be determined based on the read start address of the first storage section during storage.

The storage start address of the CF/SD from the first storage section may be acquired, and data may be written at the storage start address when a trigger has been generated.

(8) According to one embodiment of the invention, there is provided a computer-readable medium storing a computer program for controlling a data recording system that records input data, the computer program comprising:

generating a plurality of triggers each of which is generated when an event that is to be recorded is detected;

performing a data acquisition process that acquires and stores the input data in a first storage section; and

storing first storing-target data corresponding to a first trigger of the plurality of triggers within a target period that is a predetermined period beginning at a first time before the generation of the first trigger and ending at a second time after the generation of the first trigger in the first storage section;

reading the first storing-target data from the first storage section and storing the first storing-target data in a second storage section;

setting a subsequent trigger reception period after the first trigger has been generated;

storing second storing-target data corresponding to a second trigger of the plurality of triggers in the first storage section when the second trigger has been generated within the subsequent trigger reception period; and

reading the second storing-target data from the first storage section and storing the second storing-target data in the second storage section.

(9) According to one embodiment of the invention, there is provided a semiconductor device comprising:

a trigger generation section that generates a plurality of triggers each of which is generated when the trigger generation section has detected an event that is to be recorded;

a data acquisition section that performs a data acquisition process that acquires and stores input data in a first storage section; and

a data storing section,

the data storing section reading first storing-target data corresponding to a first trigger of the plurality of triggers from the first storage section and storing the first storing-target data in a second storage section, the first storing-target data having been acquired within a target period that is a predetermined period beginning at a first time before the generation of the first trigger and ending after the generation of the first trigger,

the data storing section setting a subsequent trigger reception period after the first trigger has been generated,

the data storing section storing second storing-target data corresponding to a second trigger of the plurality of triggers in the first storage section when the second trigger has been generated within the subsequent trigger reception period, and

the data storing section reading the second storing-target data from the first storage section and storing the second storing-target data in the second storage section.

(10) According to one embodiment of the invention, there is provided a drive recorder comprising:

the above-described data recording system;

an imaging section;

a first storage section; and

a second storage section,

the trigger generation section determining whether or not an event that is to be recorded has occurred based on a detection result of an impact detection section, and generating the plurality of triggers based on the determination result.

Embodiments of the invention will be described below with reference to the drawings. Note that the invention is not limited to the following embodiments. The semiconductor device according to this invention includes configuration in which the elements in the following description and modification are arbitrarily combined.

A data recording system to which the invention is applied is described below.

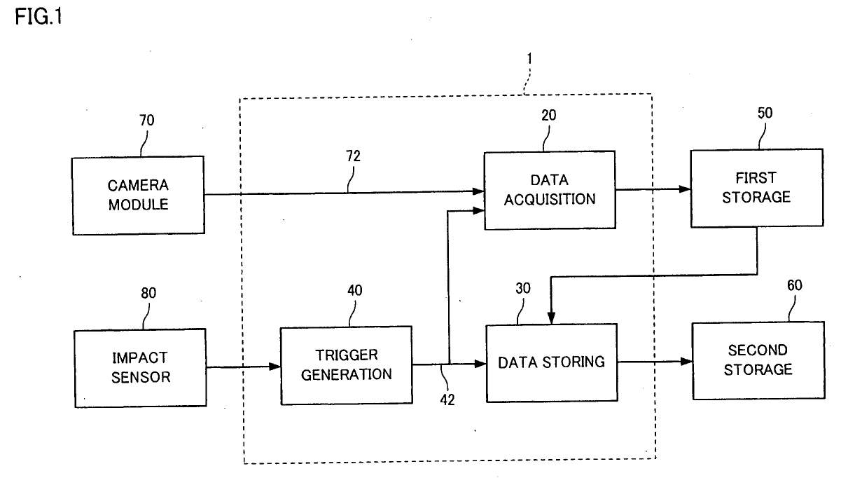

FIG. 1 is a functional block diagram showing a data recording system 1 according to one embodiment of the invention. The data recording system 1 records acquired data such as image data, sound data, and a value detected by a sensor. The data recording system 1 according to this embodiment may be implemented by a semiconductor device (integrated circuit device (IC)).

The data recording system 1 according to this embodiment includes a trigger generation section 40 that generates a trigger when the trigger generation section 40 has detected a data storing event. The trigger generation section 40 may receive a value detected by an impact sensor 80 or the like, determine whether or not the data storing event has occurred based on the detected value, and generate a trigger signal 42, for example.

The data recording system 1 according to this embodiment includes a data acquisition section 20 that performs a data acquisition process that stores acquired data in a first storage section 50 (SDRAM or ring buffer) in real time.

The first storage section 50 may be implemented by an SDRAM or the like provided inside or outside of the data recording system (IC), for example. The first storage section 50 may be used as a ring buffer, and acquired data may be written into the first storage section 50 in real time.

The data recording system 1 according to this embodiment includes a data storing section 30 that reads storing-target data in a target period from the first storage section 50 when a trigger has been generated, after all the storing-target data has been stored in the first storage section 50, and stores the storing-target data read from the first storage section 50 in a second storage section 60, the target period being a predetermined period around (before, after, or before and after) the trigger generation timing.

The data storing section 30 sets a subsequent trigger reception period after a trigger has been generated, extends the target period when a new trigger has been generated within the subsequent trigger reception period, reads new storing-target data in the extended target period from the first storage section 50 after the new storing-target data has been completely stored in the first storage section 50, and stores the new storing-target data read from the first storage section 50 in the second storage section (or a nonvolatile storage section) 60.

The data acquisition section 20, the data storing section 30, and the trigger generation section 40 may be implemented by means of software by causing a CPU to execute a program that causes the CPU to function as each section, or may be implemented by means of hardware by providing a dedicated circuit that implements the function of each section.

The data storing section 30 may extend the subsequent trigger reception period when an additional trigger has been generated within the subsequent trigger reception period.

The data acquisition section 20 may not perform the data acquisition process within a storage process period in which the data read from the first storage section 50 is stored in the second storage section 60.

The data acquisition section 20 may stop the data acquisition process when the number of triggers generated within the subsequent trigger reception period has reached a predetermined value.

When the target period exceeds a predetermined period, the data acquisition section 20 may not perform the data acquisition process in a period out of the predetermined period.

The data acquisition section 20 may determine a target period permissible value based on information relating to the amount of stored data, and may set the predetermined period based on the permissible value.

The data acquisition section 20 may suspend the data acquisition process when data is read from the first storage section and stored in the second storage section (nonvolatile storage section), and may resume the data acquisition process when a trigger has been generated after suspending the data acquisition process.

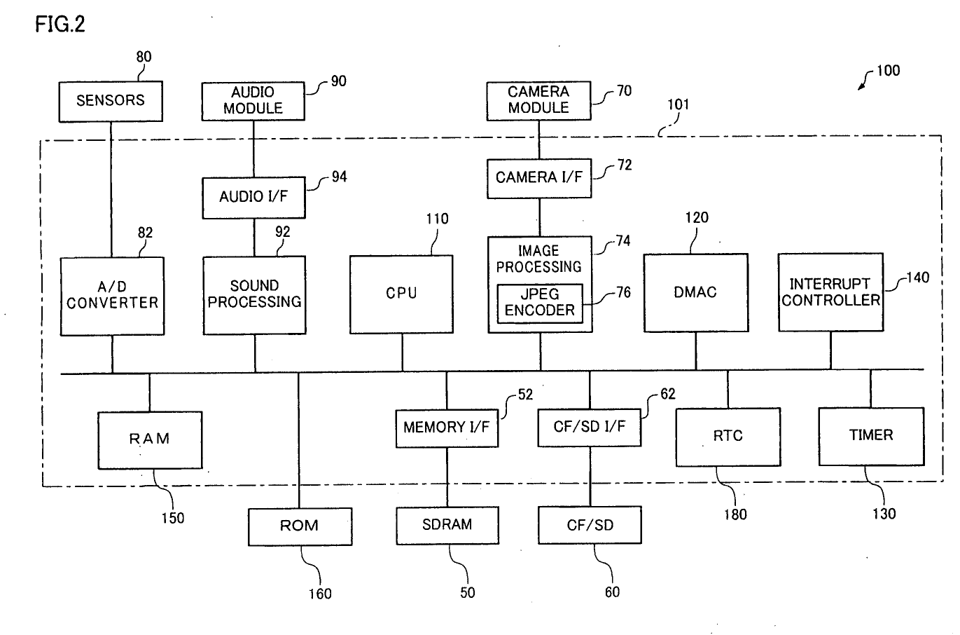

FIG. 2 is a hardware block diagram showing a drive recorder 100 including the data recording system 1 according to this embodiment.

The drive recorder 100 (including the data recording system 1) may be configured as a system provided in a moving body such as a car (e.g., a drive recorder system provided in a car).

The drive recorder 100 according to this embodiment includes a data recording integrated circuit device (IC) 101. The data recording integrated circuit device (IC) 101 may be implemented by a semiconductor device. The drive recorder 100 may include a camera module 70, an audio module 90, a sensor 80, a CF/SD card (second storage section) 60, and an SDRAM (first storage section) 50 connected to the data recording IC 101.

The image data recording IC 101 includes a CPU 110, an image processing circuit 74, a camera I/F 72, a direct memory access controller (DMAC) 120, an A/D converter (sensor I/F) 82, a sound processing circuit 92, an audio I/F 94, an interrupt controller 140, an RTC 180, a CF/SD I/F 62, a memory I/F 52, a ROM 160, a RAM 150, a timer 130, and the like.

The CPU 110 performs various data recording processes according to a control program stored in the ROM 160. The CPU 110 functions as the data acquisition section 20, the data storing section 30, and the trigger generation section 40.

The CPU 110 and the DMAC 120 cooperate to function as a data acquisition section that performs a data acquisition process that stores image data acquired by the camera module 70, sound data acquired by the audio module 90, or a measured value acquired by the sensor 80 in the SDRAM (first storage section) 50, and stores the acquired data in the SDRAM (first storage section) 50 in real time.

The CPU 110 may directly transfer the image data acquired by the camera module 70 to the SDRAM (first storage section), or may cause the DMAC 120 to transfer the image data acquired by the camera module 70 to the SDRAM (first storage section), for example.

The camera I/F 72 is connected to the camera module 70, and receives image data of an image captured by the camera module. The image processing circuit 74 processes (e.g., performs resizing (cropping) or JPEG compression) the image data received from the camera I/F 72, and generates image data in a recording format. The image processing circuit 60 includes a JPEG encoder 76 and the like.

The camera module 70 includes a light-receiving element that converts incident light into an electrical signal, an optical system (e.g., an optical system that includes optical elements such as a lens and a mirror) that causes light to be incident on the light-receiving element, a processing section that performs a predetermined process on the electrical signal output from the light-receiving element, and the like. For example, the camera module 70 may be implemented by a CCD camera or the like. The camera module 70 may be provided in a moving body such as a car, and may be configured to acquire a plurality of pieces of image data in time series. For example, the camera module 70 may be configured to acquire image data at 30 frames per second. Note that two or more camera modules may be connected.

The audio I/F 94 is connected to the audio module 90, and receives sound data collected by the audio module 90. The sound processing circuit 92 performs a sound process (e.g., compression) on the sound data received from the audio I/F 94 to generate sound data in a recording format.

The audio module 90 may include a microphone or the like.

The sensor 80 is a sensor for detecting an accident such as a collision, and may be implemented by an acceleration sensor, a gyrosensor, or the like. The sensor 80 may also be implemented by another sensor that can detect the impact due to an accident.

The A/D converter (sensor I/F) 82 is connected to the sensor 80. The A/D converter 82 receives a value measured by the sensor 80, and analog/digital-converts the received measured value.

The CF (CompactFlash)/SD (Secure Digital) card is a rewritable nonvolatile memory, and functions as the second storage section.

The data recording IC 101 according to this embodiment encodes the output from the camera module 70 into JPEG data at constant intervals, and successively stores the JPEG data in the SDRAM 50. The SDRAM 50 may be used as a ring buffer. A trigger is generated when a data storing event has been detected based on the value measured by the sensor 80. The data acquired within several tens of seconds before and after the trigger has been generated is read from the SDRAM 50 and stored in the CF/SD 60. Note that an audio input, an external pulse input, and analog input data may also be stored successively in the SDRAM 50, and the data acquired within several tens of seconds before and after the trigger has been generated may be read from the SDRAM 50 and stored in the CF/SD 60.

The data stored in the CF/SD 60 is hereinafter referred to as event log data. The event log data includes JPEG data captured (imaged) by the camera module 70, audio data acquired by the audio module 90, the value of the A/D converter 82, the count value of the timer 130, the trigger generation date (acquired by the RTC 180), the first valid data acquisition date, and the like.

The data within the target period (up to several tens of seconds) before and after the trigger generation timing is stored in the CF/SD 60. The target period may be set at five seconds (M (before trigger)=three seconds, and N (after trigger)=two seconds) as the default. A setting file for setting M and N may be provided.

The event log data may be stored sequentially after storing the trigger generation date.

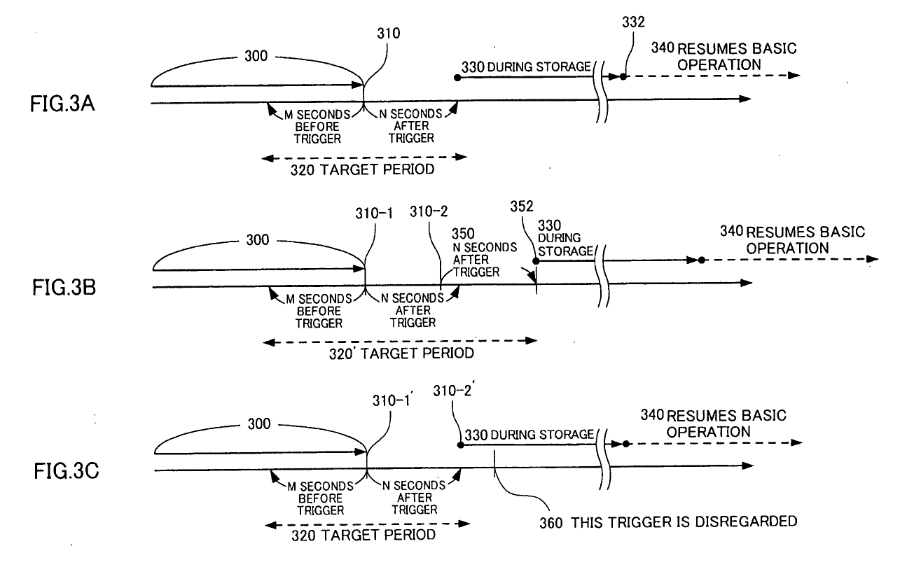

FIGS. 3A to 3C are views illustrative of a successive trigger handling operation according to this embodiment.

Reference numeral 300 indicates a trigger wait state before a trigger 310. Since the event log data before generation of the trigger 310 must be stored in the trigger wait state 300, the data is successively recorded in the SDRAM (i.e., the data acquisition process (basic operation) is performed).

Reference numeral 320 indicates the range (target period) of the event log data stored in the CF/SD. The target period 320 includes M seconds before the trigger generation timing and N seconds after the trigger generation timing.

Reference numeral 330 indicates a suspend state (i.e., data is stored in the CF/SD) in which another operation may not be accepted.

FIG. 3A is a view illustrative an operation when a single trigger is generated.

When N seconds has elapsed (the target period 320 has been completed) after the generation of the trigger 310, the data is stored in the CF/SD (330). A next trigger is not generated when the data is being stored in the CF/SD (330). The data acquisition process (basic operation) is resumed (340) after the data has been completely stored so that a new trigger can be accepted. When a new trigger has been generated immediately after the data has been completely stored (332), the event log data for M seconds may not be obtained.

FIG. 3B is a view illustrative of an operation when triggers are successively generated.

After the first trigger 310-1 has been generated, the second trigger 310-2 is generated within N seconds. In this case, the data within N seconds (350) (up to 352) after the second trigger 310-2 has been generated is recorded in the CF/SD. As a result, the event log data within an extended target period 320′ is stored in the CF/SD. Likewise, the target period is extended when the subsequent trigger has been generated within N seconds from the preceding trigger. Note that recording of data in the SDRAM stops when it is impossible to store the data in the SDRAM.

This applies to the case where the data in the target period exceeds the capacity of the SDRAM, for example. In this case, when the SDRAM is formed as a ring buffer, the data in the target period is overwritten. Therefore, when the target period exceeds a predetermined period, the data acquisition process may not be performed in a period out of the predetermined period.

For example, when the SDRAM 50 has a capacity of 128 MB and the image data storage area is 112 MB, image data for about 26 seconds can be stored in the image data storage area when the maximum size of JPEG data is 70 KB. Therefore, when the target period exceeds 26 seconds (a predetermined period), the data acquisition process may not be performed in a period out of the predetermined period.

When the target period exceeds a predetermined period, extension of the target period or the subsequent trigger reception period may be stopped.

Although this embodiment has been described taking an example in which the image data storage time is calculated based on the maximum size of JPEG data, the invention is not limited thereto. For example, when information relating to the amount of stored image data (e.g., information relating to the storage format (VGA or QVGA) of image data) is set in a register or the like, the information relating to the amount of stored image data may be acquired, the target period permissible value may be determined based on the acquired information, and the predetermined period may be set based on the permissible value.

Whether or not data can be stored in the SDRAM may be determined based on the number of triggers generated within the subsequent trigger reception period, for example. Specifically, the data acquisition process may be stopped when the number of triggers generated within the subsequent trigger reception period has reached a predetermined value (successive trigger maximum value). Alternatively, extension of the target period or the subsequent trigger reception period may be stopped when the number of triggers generated within the subsequent trigger reception period has reached a predetermined value (successive trigger maximum value).

FIG. 3C is a view illustrative of an operation in the case where a trigger is generated when data is stored in the CF/SD (330).

After a first trigger 310-1′ has been generated, a second trigger 310-2′ is generated after N seconds or more has elapsed. In this case, since data is stored in the CF/SD (330), the second trigger 310-2′ is disregarded. Specifically, the data acquisition process (basic operation) is not performed when data is stored in the CF/SD (330). Therefore, data is not stored in the CF/SD from the SDRAM.

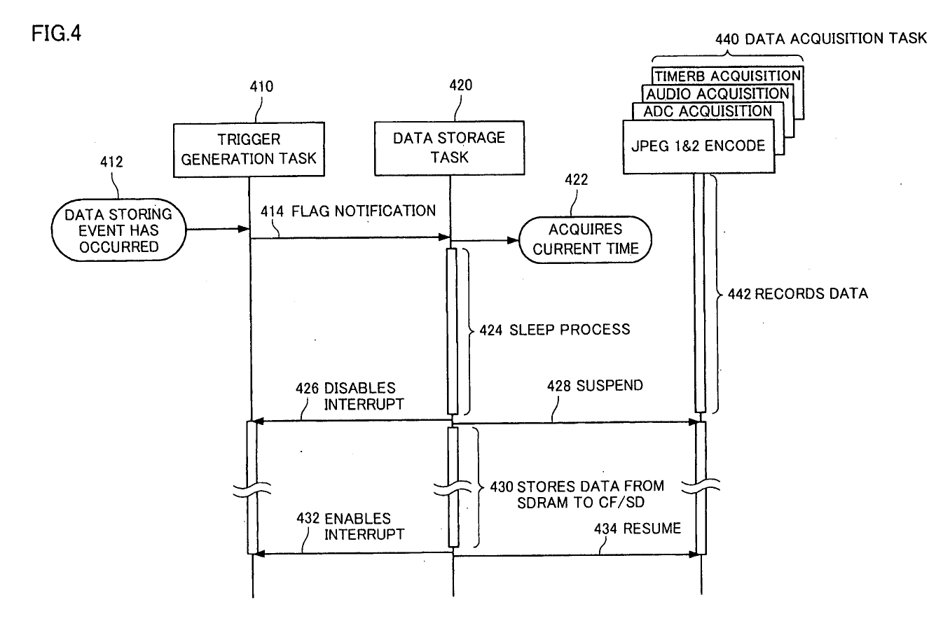

FIG. 4 shows event log data acquisition when a single trigger is generated and a process flow when a trigger is generated.

FIG. 4 shows the process flow of a trigger generation task 410, a data storage task 420, and a data acquisition task 440 when a single trigger is generated (see FIG. 3A).

When a data storing event (e.g., a collision; occurrence of collision may be determined based a value measured by an impact sensor) has occurred (412), the trigger generation task 410 notifies the data storage task 420 that a flag has been set (414).

The data storage task 420 receives the notification 414, acquires the current time (422), is set in a sleep state for N seconds (424), and creates an event log data storage directory in the CF/SD to record the time. If the number of event log data storage directories that have been created exceeds a predetermined number, the oldest event log data storage directory is deleted (430). After N seconds (sleep state) has elapsed, the data storage task 420 issues a trigger generation interrupt cause disable request (426) and a request 428 for suspending the data acquisition task 440.

The event log data is then stored sequentially in the CF/SD from each list (430). When the storage operation has been completed, a resume request 434 for each process that has been suspended and a trigger generation interrupt cause enable request 432 are issued.

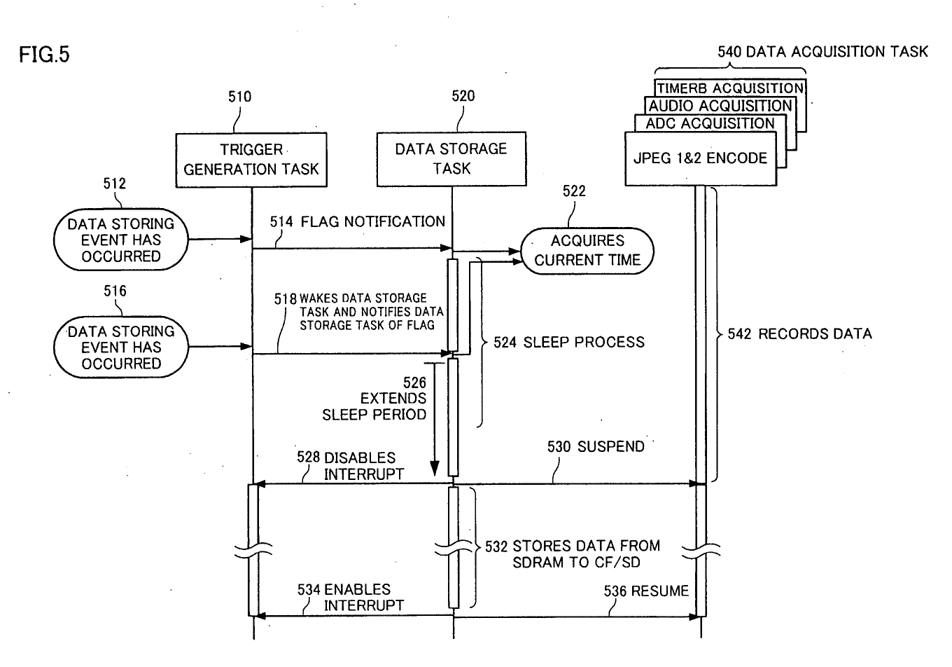

FIG. 5 shows event log data acquisition when triggers are generated successively and a process flow when a trigger is generated.

FIG. 5 shows the process flow of a trigger generation task 510, a data storage task 520, and a data acquisition task 540 when triggers are generated successively (see FIG. 3B).

When the first data storing event 512 has occurred, the trigger generation task 510 notifies the data storage task 520 that a flag has been set (514). The data storage task 520 receives the notification, acquires the current time (522), and is set in a sleep state for N seconds (524). When a data storing event 516 has occurred in the sleep period, the trigger generation task 510 wakes the data storage task 520, and notifies the data storage task 520 that a flag has been set (518). The data storage task 520 receives the notification 518, and extends the sleep period (526). The sleep period is set at N seconds in principle. However, the sleep period is set so that the sum of M seconds before the first trigger and the elapsed time from the first trigger does not exceed the permissible maximum time. The trigger generation time is stored up to fifty. When the predetermined sleep period has been completed, the data storage task 520 creates an event log data storage directory in the CF/SD, and records the trigger generation time up to fifty switch operations (532).

The data storage task 520 then issues a trigger generation task interrupt cause disable request 528 and a request 530 for suspending the data acquisition task 540.

The event log data is then stored sequentially in the CF/SD from each list (532). If an additional trigger is generated in this period, the trigger is inevitably disregarded. When the storage operation has been completed, a resume request 536 for each process that has been suspended and a trigger generation interrupt cause enable request 534 are issued.

The invention is not limited to the above-described embodiments, and various modifications can be made. The invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

1. A data recording system that records input data, the data recording system comprising:
a trigger generation section that generates a plurality of triggers each of which is generated when the trigger generation section has detected an event that is to be recorded;
a data acquisition section that performs a data acquisition process that acquires and stores the input data in a first storage section; and
a data storing section,
the data storing section reading first storing-target data corresponding to a first trigger of the plurality of the triggers from the first storage section and storing the first storing-target data in a second storage section, the first storing-target data having been acquired within a target period that is a predetermined period beginning at a first time before the generation of the first trigger and ending at a second time after the generation of the first trigger,
the data storing section setting a subsequent trigger reception period after the first trigger has been generated,
the data storing section storing second storing-target data corresponding to a second trigger of the plurality of the triggers in the first storage section when the second trigger has been generated within the subsequent trigger reception period, and
the data storing section reading the second storing-target data from the first storage section and storing the second storing-target data in the second storage section.

2. The data recording system as defined in claim 1,
the data storing section extending the subsequent trigger reception period when an additional trigger has been generated within the subsequent trigger reception period.

3. The data recording system as defined in claim 1,
the data acquisition section not performing the data acquisition process within a storage process period in which data read from the first storage section is stored in the second storage section.

4. The data recording system as defined in claim 2,
the data acquisition section not performing the data acquisition process within a storage process period in which data read from the first storage section is stored in the second storage section.

5. The data recording system as defined in claim 2,
the data acquisition section suspending the data acquisition process when the number of triggers that have been generated within the subsequent trigger reception period has reached a predetermined value.

6. The data recording system as defined in claim 4,
the data acquisition section suspending the data acquisition process when the number of triggers that have been generated within the subsequent trigger reception period has reached a predetermined value.

7. The data recording system as defined in claim 1,
the data acquisition section not performing the data acquisition process in a period out of a predetermined period when the target period exceeds the predetermined period.

8. The data recording system as defined in claim 2,
the data acquisition section not performing the data acquisition process in a period out of a predetermined period when the target period exceeds the predetermined period.

9. The data recording system as defined in claim 3,
the data acquisition section not performing the data acquisition process in a period out of a predetermined period when the target period exceeds the predetermined period.

10. The data recording system as defined in claim 4,
the data acquisition section not performing the data acquisition process in a period out of a predetermined period when the target period exceeds the predetermined period.

11. The data recording system as defined in claim 7,
the data acquisition section determining a target period permissible value based on information relating to the amount of stored data, and setting the predetermined period based on the target period permissible value.

12. The data recording system as defined in claim 8,
the data acquisition section determining a target period permissible value based on information relating to the amount of stored data, and setting the predetermined period based on the target period permissible value.

13. The data recording system as defined in claim 9,
the data acquisition section determining a target period permissible value based on information relating to the amount of stored data, and setting the predetermined period based on the target period permissible value.

14. The data recording system as defined in claim 10,
the data acquisition section determining a target period permissible value based on information relating to the amount of stored data, and setting the predetermined period based on the target period permissible value.

15. The data recording system as defined in claim 1,
the data acquisition section suspending the data acquisition process when data is read from the first storage section and stored in the second storage section, and resuming the data acquisition process when a trigger has been generated after suspending the data acquisition process.

16. The data recording system as defined in claim 2,
the data acquisition section suspending the data acquisition process when data is read from the first storage section and stored in the second storage section, and resuming the data acquisition process when a trigger has been generated after suspending the data acquisition process.

17. A computer-readable medium storing a computer program for controlling a data recording system that records input data, the computer program comprising:
generating a plurality of triggers each of which is generated when an event that is to be recorded is detected;
performing a data acquisition process that acquires and stores the input data in a first storage section;
storing first storing-target data corresponding to a first trigger of the plurality of triggers within a target period that is a predetermined period beginning at a first time before the generation of the first trigger and ending at a second time after the generation of the first trigger in the first storage section;
reading the first storing-target data from the first storage section and storing the first storing-target data in a second storage section;
setting a subsequent trigger reception period after the first trigger has been generated;
storing second storing-target data corresponding to a second trigger of the plurality of triggers in the first storage section when the second trigger has been generated within the subsequent trigger reception period; and
reading the second storing-target data from the first storage section and storing the second storing-target data in the second storage section.

18. A semiconductor device comprising:
a trigger generation section that generates a plurality of triggers each of which is generated when the trigger generation section has detected an event that is to be recorded;
a data acquisition section that performs a data acquisition process that acquires and stores input data in a first storage section; and
a data storing section,
the data storing section reading first storing-target data corresponding to a first trigger of the plurality of triggers from the first storage section and storing the first storing-target data in a second storage section, the first storing-target data having been acquired within a target period that is a predetermined period beginning at a first time before the generation of the first trigger and ending at a second time after the generation of the first trigger,
the data storing section setting a subsequent trigger reception period after the first trigger has been generated,
the data storing section storing second storing-target data corresponding to a second trigger of the plurality of triggers in the first storage section when the second trigger has been generated within the subsequent trigger reception period, and
the data storing section reading the second storing-target data from the first storage section and storing the second storing-target data in the second storage section.

19. A drive recorder comprising:
the data recording system as defined in claim 1;
an imaging section;
a first storage section; and
a second storage section,
the trigger generation section determining whether or an event that is to be recorded has occurred based on a detection result of an impact detection section, and generating the plurality of triggers based on the determination result.

20. A drive recorder comprising:
the data recording system as defined in claim 2;
an imaging section;
a first storage section; and
a second storage section,
the trigger generation section determining whether or not an event that is to be recorded has occurred based on a detection result of an impact detection section, and generating the plurality of triggers based on the determination result.

21. A drive recorder comprising:
the data recording system as defined in claim 3;
an imaging section;
a first storage section; and
a second storage section,
the trigger generation section determining whether or not an event that is to be recorded has occurred based on a detection result of an impact detection section, and generating the plurality of triggers based on the determination result.

22. A drive recorder comprising:
the data recording system as defined in claim 4;
an imaging section;
a first storage section; and
a second storage section,
the trigger generation section determining whether or not an event that is to be recorded has occurred based on a detection result of an impact detection section, and generating the plurality of triggers based on the determination result.
